(19) United States
(12) Patent Application Publication
(10) Pub. No.: US 2019/0066172 A1
(43) Pub. Date: Feb. 28, 2019

(54) System and Method of Reducing Processing and Network Traffic

(71) Applicant: Bank of America Corporation, Charlotte, NC (US)

(72) Inventors: Therese H. Willis, Apopka, FL (US); Charles Andrew Boyd, Flower Mound, TX (US); Richard E. Farnum, Indian Land, SC (US); Monte D. Harmon, Albuquerque, NM (US); Martha Sain McClellan, Lancaster, SC (US); John C. Monteiro, Cumberland, RI (US); James J. Park, Barrington, IL (US); James Christian Storey, Thomson, GA (US)

(21) Appl. No.: 15/692,564

(22) Filed: Aug. 31, 2017

(51) Int. Cl. G06Q 30/06; G06Q 20/10; H04N 21/258; G06Q 20/14

(52) U.S. Cl. CPC G06Q 30/06; G06Q 20/10; H04L 2209/56; G06Q 20/14; H04N 21/25875

(57) ABSTRACT

In one or more embodiments, one or more systems, methods, and/or processes may receive, via a network and from at least one account processor computer system, requests for compensations associated with a first account; provide the compensations from the first account to a second account; receive, via the network, user credentials from a customer computer system; authenticate the user credentials with a database; receive information from the customer computer system that indicates cessation of compensation associated with the second account; and provide cessation information to account processor computer systems, that includes the at least one account processor computer system, to prevent at least one future transaction based on a request for compensation from the first account. For example, another request for another compensation associated with the first account from an account processor computer system and associated with the second account may be received, and the other request may be declined.

### TECHNICAL FIELD

Certain embodiments of this disclosure relate generally to processing and network traffic.

### BACKGROUND

Networks allow users to access various types of computing resources, which may include hardware resources and/or software resources. Examples of hardware resources include computer networks, servers, memory, and so on. Examples of software resources include applications, services, data, and so on. The computing resources may be used to process transactions. Data stores and databases can support various data types including traditional file, video, images, etc. within a name space leading to new opportunities and innovations. These data stores can have virtually unlimited storage capacity with extremely high durability and availability along with low costs leading to widespread adoption.

### SUMMARY

In one or more embodiments, one or more systems, methods, and/or processes may receive, via a network, requests for compensations associated with a first account from at least one account processor computer system and may provide the compensations from the first account to a second account. For example, the requests for compensations associated with the first account (e.g., an account of a banking customer) may include periodic payments for one or more goods and/or one or more services. In one instance, the requests for compensations associated with the first account may include periodic payments for a gym membership. In a second instance, the requests for compensations associated with the first account may include periodic payments for periodic delivery of one or more household items. In another instance, the requests for compensations associated with the first account may include periodic payments for a streaming media service (e.g., a streaming video service, a streaming music service, etc.).

In one or more embodiments, the one or more systems, methods, and/or processes may receive, via the network, user credentials from a customer computer system, which may be authenticated with a database, and may receive information from the customer computer system that indicates cessation of compensation associated with the second account. For example, a customer may desire for at least one future compensation associated with the second account not to occur. In one instance, the customer may desire for any future compensation associated with the second account not to occur. In another instance, the customer may desire for any future compensation associated with the second account not to occur for a period of time, and after the period of time future, compensations associated with the second account may be permitted to occur. In one or more embodiments, the one or more systems, methods, and/or processes may provide cessation information to account processor computer systems, that includes the at least one account processor computer system, to prevent at least one future transaction based on a request for compensation from the first account. For example, another request for another compensation associated with the first account from an account processor computer system and associated with the second account may be received, and the other request may be declined.

In one or more embodiments, providing cessation information to account processor computer systems may reduce network traffic. For example, the account processor computer systems may be associated with one or more of debit/credit processing networks, such as one or more of NYCE, MAESTRO, PULSE, STAR, SHAZAM, and PAYPAL, among others. For instance, network traffic associated with processing compensations beyond and/or after one or more of debit/credit processing networks, such as network traffic associated with processing compensations with one or more brand computer systems (e.g., VISA, MASTERCARD, DISCOVER, etc) and/or one or more issuer computer systems, may be reduced and/or eliminated as compensations may be declined at the debit/credit processing network level.

In one or more embodiments, cessation information may be managed by an issuer computer system configured to process compensations from multiple debit/credit processing networks. For example, utilizing the issuer computer system to manage cessation information may reduce network traffic that would otherwise be required to apply the cessation information to each of the debit/credit processing networks. in one or more embodiments, the issuer computer system may be configured to apply the cessation information based on characteristics of the compensation (such as an identity of a merchant associated with a purveyor computer system) without the issuer computer system having to know from which debit/credit processing network(s) it should expect to receive the compensation. For example, configuring the issuer computer system to apply the cessation information based on, e.g., the merchant may prevent that merchant from circumventing a denial of compensation by retrying a denied compensation on multiple debit/credit processing network.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of a computer system, according to one or more embodiments;

FIG. 2 illustrates an example of computer systems coupled to a network, according to one or more embodiments;

FIGS. 3A and 3B illustrates an example method of processing compensation, according to one or more embodiments;

FIG. 4 illustrates an example method of processing a cessation of compensation, according to one or more embodiments;

FIGS. 5A and 5B illustrates another example method of processing compensation, according to one or more embodiments;

FIG. 6 illustrates an example of a method of operating a computer system, according to one or more embodiments; and

FIG. 7 illustrates an example of a customer computer system, a purveyor computer system, an account processor computer system, a payment brand computer system, and an issuer computer system coupled to a network, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all. possible embodiments.

As used herein, a reference numeral followed by a letter refers to a specific instance of an element and the numeral only form of the reference numeral refers to the collective element. Thus, for example, device ‘12A’ refers to an instance of a device class, which may be referred to collectively as devices ‘12’ and any one of Which may be referred to generically as a device ‘12’.

In one or more embodiments, a computer system may receive a request for a cessation of compensation associated with two accounts. For example, a first account of the two accounts may be an account of a user, and a second account of the two accounts may be an account of a purveyor of one or more goods and/or one or more services. In one or more embodiments, the purveyor may periodically attempt to collect compensation. For example, the purveyor may periodically attempt to have compensation transferred from the first account to the second account. In one or more embodiments, the request for the cessation of the compensation associated with two accounts may include a cessation of at least one future compensation transferred from the first account to the second account. For example, one or more periodic attempts to have compensation transferred from the first account to the second account may not be permitted. For instance, at least one future attempt to have compensation transferred from the first account to the second account may be denied and/or declined.

In one or more embodiments, the computer system may provide cessation information to one or more account processor computer systems in response to receiving the request for the cessation of compensation associated with the two accounts. For example, the one or more account processor computer systems may receive compensation request information from one or more purveyor to transfer compensation from the first account to the second account, and based at least on the cessation information may not utilize a process and/or method to transfer compensation from the first account to the second account. For instance, the one or more account processor computer systems may be operated by one or more of VISA, MASTERCARD, DISCOVER, NYCE, MAESTRO, PULSE, STAR, SHAZAM, and PAYPAL, among others. In one or more embodiments, the computer system may receive a request for a cessation of compensation associated with the two accounts for a period of time. For example, the cessation of compensation associated with the two accounts for the period of time may include that compensation is not transferred during the period of time, and the compensation is permitted to be transferred after the period of time.

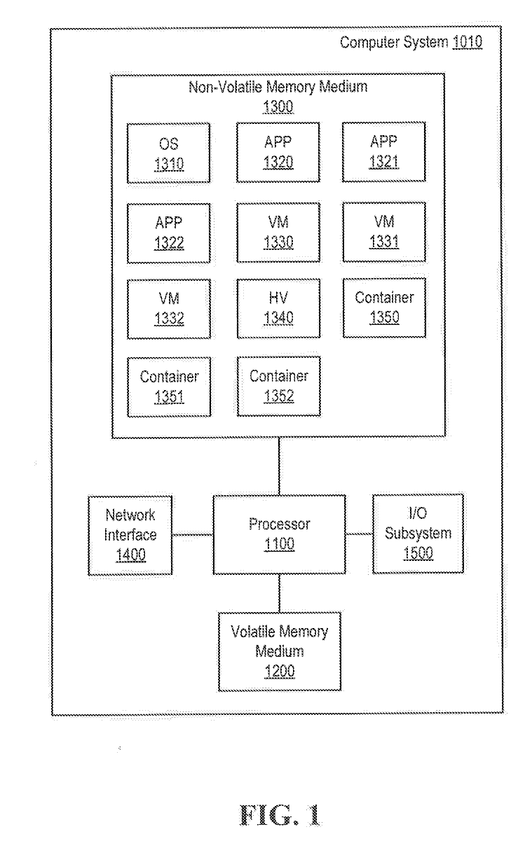

Turning now to FIG. 1, an example of a computer system is illustrated, according to one or more embodiments. As shown, a computer system 1010 may include a processor 1100, a volatile memory medium 1200, a non-volatile memory medium 1300, a network interface 1400, and an input/output (I/O) subsystem 1500. As illustrated, volatile memory medium 1200, non-volatile memory medium 1300, network interface 1400, and I/O subsystem 1500 may be communicatively coupled to processor 1100.

As shown, non-volatile memory medium 1300 may include an operating system (OS) 1310, applications (APPs) 1320-1322, virtual machines (VMs) 1330-4332, a hypervisor (HV) 1340, and containers 1350-1352. In one or more embodiments, one or more of OS 1310, APPs 1320-1322, VMs 1330-1332, HV 1340, and containers 1350-1352 may include instructions executable by processor 1100. In one example, processor 1100 may execute instructions of one or more of OS 1310, APPs 1320-1322, VMs 1330-1332, HV 1340, and containers 1350-4352 via non-volatile memory medium 1300. In another example, one or more portions of the instructions of the one or more of OS 1310, APPs 1320-1332, VMs 1330-1332, HV 1340, and containers 1350-1352 may be transferred to volatile memory medium 1200, and processor 1100 may execute the one or more portions of the instructions of the one or more of OS 1310, APPs 1320-1332, VMs 1330-1332, HV 1340, and containers 1350-1352 via volatile memory medium 1200.

In one or more embodiments, HV 1340 may include one or more of software, firmware, and hardware that creates and executes one or more VMs (e.g., one or more of VMs 1330-4332). For example, computer system 1010 may be considered host machine when HV 1340 executes and one or more of VMs 1330-1332 are executed via HV 1340. For instance, a virtual machine (VM) (e.g., a VM of VMs 1330-1332) may be considered a guest machine, in one or more embodiments, a VM may provide one or more structures and/or functionalities as those described with reference to computer system 1010 (e.g., singularly or via nesting of hypervisors and virtual machines). In one example, the VM may provide emulated devices to a guest OS that executes via the VM. In another example, the VM may provide hardware devices to the guest OS that executes via the VM. In one instance, the guest OS may access hardware in a pass-through configuration. In another instance, the guest OS may access hardware in a single root input/output virtualization (SR-IOV) configuration. In one or more embodiments, guest operating systems may share one or more devices of a host machine. For example, the guest operating systems may share one or more of a network adapter via virtual network adapters and a storage device via a virtual storage devices (e.g., virtual disks, virtual memory, etc.), among others.

In one or more embodiments, OS level virtualization may be utilized. For example, OS level virtualization may include a kernel of an OS that permits multiple isolated user space instances of collections of processes (e.g., programs, applications, services, etc.). For instance, these instances are often referred to as “containers”, “software containers”, “virtualization engines”, or “jails” (e.g., FreeBSD jails, chroot jails, etc.), in one or more embodiments, with OS level virtualization, an OS may behave and/or may appear like multiple different, individual computer systems. For example, little to no overhead may be imposed by OS level virtualization, as processes in OS level virtual partitions may utilize a single system call interface of an OS. For instance, OS level virtual partitions may not be subjected to emulation or be executed via virtual machines. In one or more embodiments, OS level virtualization may be utilized in consolidating computer system hardware or virtual machines by moving services on separate hosts or virtual machines into containers on a computer system or single virtual machine.

In one or more embodiments, a container may be or include software in a file system that includes one or more of instructions executable by a processor (e.g., a program, software, an application, server software, a service, etc.), one or more runtime libraries, one or more system tools, and one or more system libraries, among others. For example, a container may be or include a Docker container, a or a Kubernetes pod, among others. In one or more embodiments, a container may provide and/or may implement operating system-level virtualization via a virtual environment that includes a separate process space and/or a separate network space, rather than creating and/or implementing a virtual machine.

In one or more embodiments, a container may be or include a pod (e.g., a Kubernetes pod). For example, a pod may provide and/or add a higher level of abstraction to one or more containerized elements. For instance, a pod may include one or more containers that may be warranted to be co-located and/or executed on a computer system (e.g., a host computer system, host machine, etc.) and may share resources of the computer system. In one or more embodiments, a thick container may be or include a pod, and a thin container may include a single container.

In one or more embodiments, containers may provide and/or offer an immutable quality and/or option. For example, a container may be deployed, destroyed, modified, re-constructed and/or re-created, and re-deployed. In one instance, instructions, executable by a processor, of a container may not be modified while the container is executing. In another instance, instructions, executable by a processor, of a container may not be modified once the container is created.

In one or more embodiments, the term “memory medium” may mean a “memory device”, a “memory”, a “storage device”, a “tangible computer readable storage medium”, and/or a “computer-readable medium”. In one example, a memory medium may be a volatile memory medium. For instance, the volatile memory medium may lose stored data when the volatile memory medium no longer receives power. In a second example, a memory medium may be a non-volatile memory medium. For instance, the non-volatile memory medium may not lose stored data when the volatile memory medium no longer receives power or when power is not applied. In another example, a memory medium may include a volatile memory medium and a non-volatile memory medium.

In one or more embodiments, a volatile memory medium may include volatile storage. For example, the volatile storage may include random access memory (RAM), dynamic RAM (DRAM), static RAM (SRAM), and/or extended data out RAM (EDO RAM), among others. In one or more embodiments, a non-volatile memory may include non-volatile storage. For example, the non-volatile storage may include read only memory (ROM), programmable ROM (PROM), erasable PROM (EPROM), electrically erasable PROM (EEPROM), a magnetic storage medium (e.g., a hard drive, a floppy disk, a magnetic tape, etc.), ferroelectric RAM (FRAM), flash memory, a solid state drive (SSD), non-volatile RAM (NVRAM), a one-time programmable (OTP) memory, and/or optical storage (e.g., a compact disc (CD), a digital versatile disc (DVD), a BLU-RAY disc (BD), etc.), among others.

In one or more embodiments, I/O subsystem 1500 may include or represent a variety of communication interlaces, graphics interfaces, video interfaces, user input interfaces, and/or peripheral interfaces, among others. For example, I/O subsystem 1500 may include one or more of a touch screen, a display, a display adapter, and a universal serial bus (USB) interface, among others. For instance, a touch screen may include circuitry that enables touch functionality in conjunction with a display that is driven by a display adapter.

In one or more embodiments, network interface 1400 may be configured to be coupled to a network. For example, network interface 1400 may permit computer system 1010 to be communicatively coupled to a network. In one instance, network interface 1400 may be configured to be coupled to a wired network. In a second instance, network interface 1400 may be configured to be coupled to a wireless network. In a second instance, network interface 1400 may be configured to be coupled to an optical network.

In one or more embodiments, one or more of volatile memory medium 1200, non-volatile memory medium 1300, network interface 1400, and I/O subsystem 1500 may be communicatively coupled to processor 1100 via one or more buses. For example, a bus may include one or more of a peripheral component interconnect (PCI) bus, a serial peripheral interface (SPI) bus, an inter-integrated circuit (I²C) bus, an enhanced serial peripheral interface (eSPI) bus, a system management bus (SMBus), a universal serial bus, and a low pin count (LPC) bus, among others. In one or more embodiments, one or more of volatile memory medium 1200, non-volatile memory medium 1300, network interface 1400, and I/O subsystem 1500 may be communicatively coupled to processor 1100 via one or more of a PCI-Express (PCIe) root complex and one or more PCIe switches, among others.

In one or more embodiments, processor 1100 may execute instructions in implementing one or more systems, flowcharts, methods, and/or processes described herein. In one example, processor 1100 may execute processor instructions from one or more of memory media 1200 and 1300 in implementing one or more systems, flowcharts, methods, and/or processes described herein. In another example, processor 1100 may execute instructions received via network interface 1400 in implementing one or more systems, flowcharts, methods, and/or processes described herein.

In one or more embodiments, processor 1100 may include circuitry that may interpret and/or execute program instructions and/or process data, among others. For example, processor 1100 may include one or more of a system, a device, and an apparatus that may interpret and/or execute program instructions and/or process data, among others. For instance, processor 1100 may include one or more of a central processing unit (CPU), a microprocessor, a graphics processing unit (GPU), application processor, a digital signal processor (DSP), and an application specific integrated circuit (ASIC), among others.

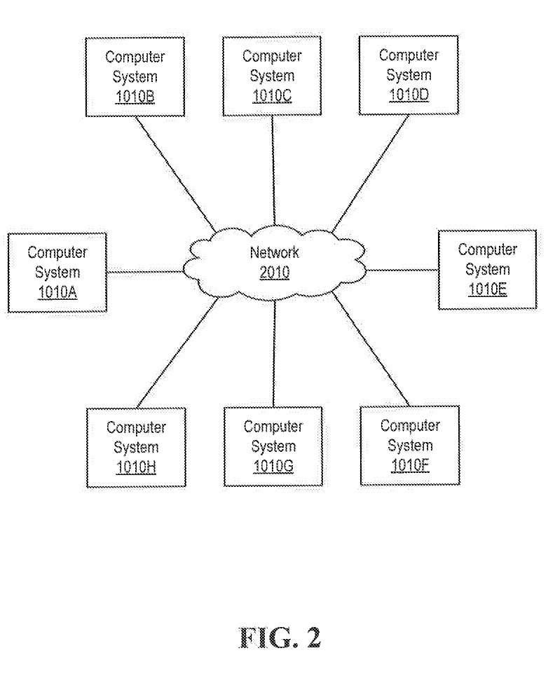

Turning now to FIG. 2, computer systems coupled to a network are illustrated, according to one or more embodiments. As shown, computer systems 1010A-1010H may be communicatively coupled to a network 2010. In one or more embodiments, network 2010 may include one or more of a wired network, an optical network, and a wireless network. For example, network 2010 may include one or more of a local area network (LAN), a wide area network (WAN), a wireless LAN (WLAN), a metropolitan area network (MAN), a public switched telephone network (PSTN), a public WAN (e.g., an Internet), a private WAN, a cellular telephone network, a satellite telephone network, and a virtual private network (VPN), among others. In one or more embodiments, network 2010 may be coupled to one or more other networks. For example, network 2010 may be coupled to one or more of a LAN, a WAN, a WLAN, a MAN, a PSTN, a public WAN, a private WAN, a cellular telephone network, a satellite telephone network, and a VPN, among others.

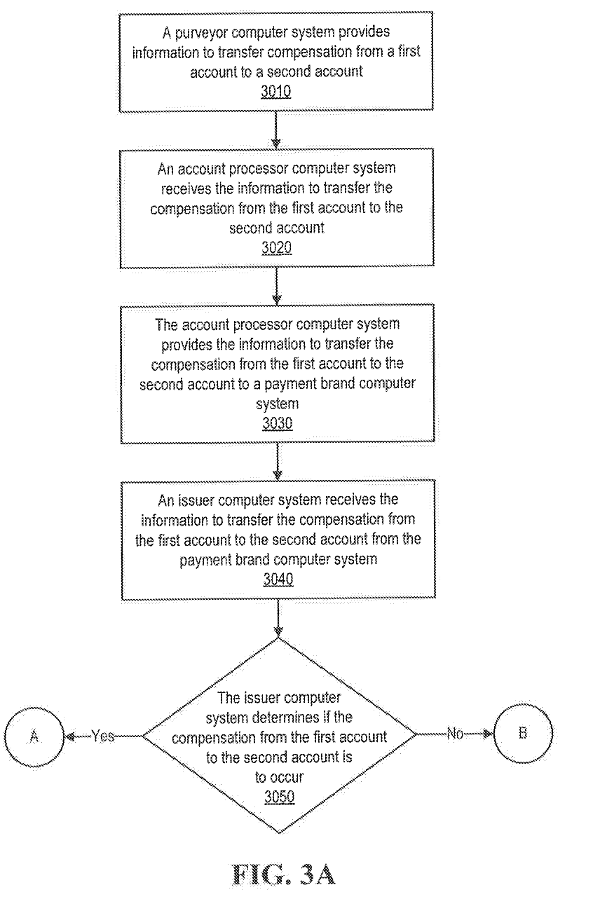

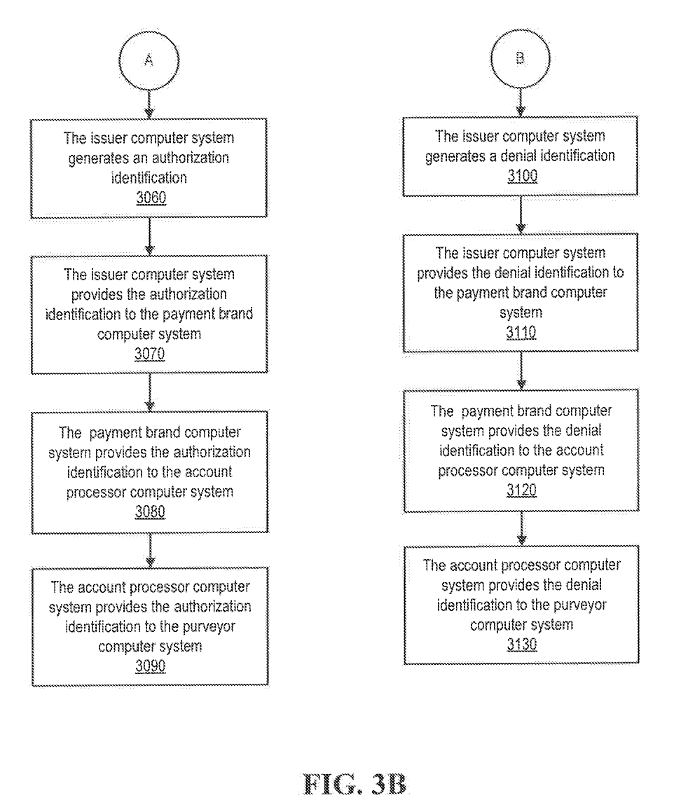

Turning now to FIGS. 3A and 3B, an example method of processing compensation is illustrated, according to one or more embodiments. At 3010, a purveyor computer system may provide information to transfer compensation from a first account to a second account. For example, the purveyor computer system (e.g., computer system 1010A) may provide, to a network (e.g., network 2010), the information to transfer compensation from the first account (e.g., a customer account) to the second account (e.g., an account of the purveyor). For instance, the compensation may be for one or more goods and/or for one or more services. In one or more embodiments, the first account may be or may be associated with one or more of a credit card account, a checking account, and a debit card account, among others.

At 3020, an account processor computer system may receive the information to transfer the compensation from the first account to the second account. For example, the account processor computer system (e.g., computer system 1010B) may receive, via the network (e.g., network 2010), the information to transfer the compensation from the first account to the second account. For instance, the account processor computer system may be a computer system associated with a debit/credit processing network, such as NYCE, PULSE, STAR, and SHAZAM, among others.

At 3030, the account processor computer system may provide the information to transfer the compensation from the first account to the second account to a payment brand computer system. For example, the account processor computer system (e.g., computer system 1010B) may provide, via the network (e.g., network 2010) the information to transfer the compensation from the first account to the second account to the payment brand computer system (e.g., computer system (computer system 1010C). For instance, the payment brand computer system may be associated with a brand, such as MASTERCARD, DISCOVER, AMERICAN EXPRESS, and VISA, among others. At 3040, an issuer computer system may receive the information to transfer the compensation from the first account to the second account from the payment brand computer system. For example, the issuer computer system (e.g., computer system 1010D) may receive, via the network (e.g., network 2010), the information to transfer the compensation from the first account to the second account from the payment brand computer system (e.g., computer system 1010C).

At 3050, the issuer computer system may determine if the compensation from the first account to the second account is to occur. In one or more embodiments, determining if the compensation from the first account to the second account is to occur may include one or more of determining if an account number associated with the second account is legitimate, determining if a card (e.g., a credit card, a debit card, etc.) associated with the second account has not been reported stolen or lost, and determining if the second account has an appropriate amount of credit and/or funds available for transfer, among others. If the issuer computer system determines that the compensation from the first account to the second account may is to occur, the issuer computer system may generate an authorization identification, at 3060. For example, the authorization identification may include an authorization number.

At 3070, the issuer computer system may provide the authorization identification to the payment brand computer system. For example, the issuer computer system may provide the authorization identification to the payment brand computer system via the network. At 3080, the payment brand computer system may provide the authorization identification to the account processor computer system. For example, the payment brand computer system may provide the authorization identification to the account processor computer system via the network.

At 3090, the account processor computer system may provide the authorization identification to the purveyor computer system. For example, the account processor computer system may provide the authorization identification to the purveyor computer system via the network. If the issuer computer system determines that the compensation from the first account to the second account may is not to occur, the issuer computer system may generate a denial identification, at 3100. For example, the denial identification may include a transaction identification and/or a denial number.

At 3110, the issuer computer system may provide the denial identification to the payment brand computer system. For example, the issuer computer system may provide the denial identification to the payment brand computer system via the network. At 3120, the payment brand computer system may provide the denial identification to the account processor computer system. For example, the payment brand computer system may provide the denial identification to the account processor computer system via the network. At 3130, the account processor computer system may provide the denial identification to the purveyor computer system. For example, the account processor computer system may provide the denial identification to the purveyor computer system via the network. In one or more embodiments, denying, and/or declining a transfer of compensation from the first account to the second account may include performing one or more of method elements 3100-3130.

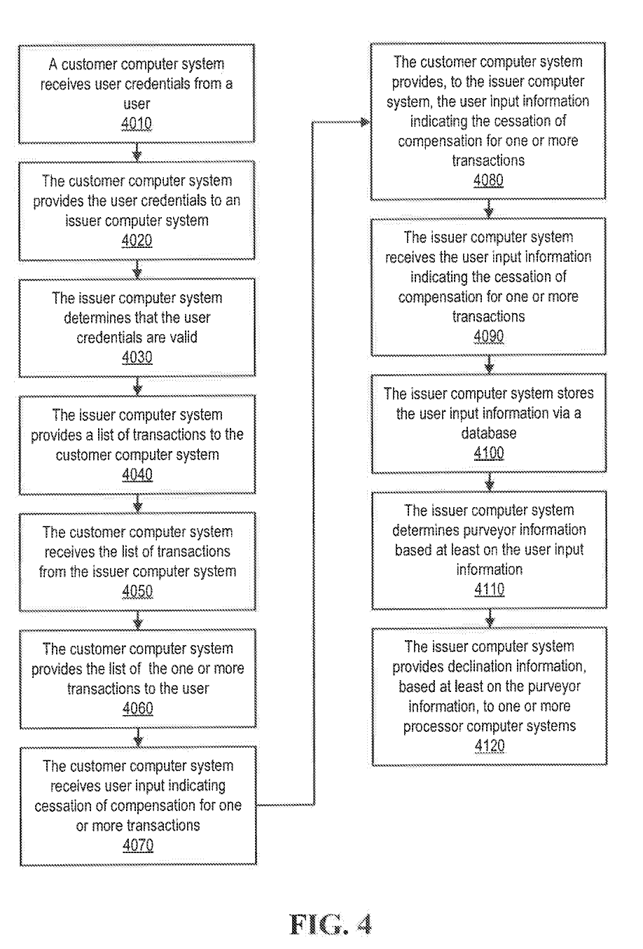

Turning now to FIG. 4, an example method of processing a cessation of compensation is illustrated, according to one or more embodiments. At 4010, a customer computer system may receive user credentials from a user. For example, the customer computer system (e.g., computer system 1010E) may receive user credentials from the user via a user interface. For instance, the user interface may include a graphical user interface (GUI). In one or more embodiments, the customer computer system may include one or more of an automated teller machine, a wireless telephone, a laptop computing device, and a tablet computing device, among others, in one example, the customer computer system may execute an APP that may receive the user credentials from the user. In a second example, the customer computer system may execute a plug-in that may receive the user credentials from the user. In another example, the customer computer system may execute a virtual machine that executes virtual machine instructions that may receive the user credentials from the user. For instance, the customer computer system may download the virtual machine instructions via a network (e.g., network 2010).

At 4020, the customer computer system may provide the user credentials to an issuer computer system. For example, the customer computer system may provide the user credentials to the issuer computer system (e.g., computer system 1010D) via a network (e.g., network 2010). In one or more embodiments, the user credentials may include one or more of a user identification (e.g., a user name), a password, a personal identification number (PIN), and an account identification (e.g., an account number), among others. At 4030, the issuer computer system may determine that the user credentials are valid. In one or more embodiments, determining that the user credentials are valid may include providing the user credentials to a database to determine that the user credentials are valid.

At 4040, the issuer computer system may provide a list of transactions to the customer computer system. For example, the list of transactions may include multiple credit card and/or debit card transactions. In one or more embodiments, the transactions may include one or more recurring compensations. For example, the one or more recurring compensations may include one or more periodic compensations. For instance, the one or more periodic compensations may include one or more compensations for one or more goods and/or one or more services. At 4050, the customer computer system may receive the list of transactions from the issuer computer system. For example, the customer computer system may receive the list of transactions from the issuer computer system via the network.

At 4060, the customer computer system may provide the list of transactions to the user, For example, the customer computer system may provide the list of transactions to the user via the user interface. At 4070, the customer computer system may receive user input indicating cessation of compensation for one or more transactions. For example, the customer computer system may receive user input indicating the cessation of compensation for one or more transactions via the user interface. In one or more embodiments, the user input indicating the cessation of compensation for one or more transactions may include information that indicates a permanent cessation of compensation for one or more transactions. For example, the user input may indicate that no more compensation may be provided to a purveyor of one or more goods and/or services. In one or more embodiments, the user input indicating the cessation of compensation for one or more transactions may include information that indicates a period of time for the cessation of compensation for one or more transactions. For example, the period of time may include any amount of time. For instance, the period of time may include one or more days, one or more weeks, one or more months, etc.

At 4080, the customer computer system may provide, to the issuer computer system, user input information indicating the cessation of compensation for one or more transactions. For example, the customer computer system may provide, to the issuer computer system via the network, the user input information indicating the cessation of compensation for one or more transactions. At 4090, the issuer computer system may receive the user input information indicating the cessation of compensation for one or more transactions. For example, the issuer computer system may receive the user input information indicating the cessation of compensation for one or more transactions via the network. At 4100, the issuer computer system may store the user input information via a database. For example, the database may include a computer system. At 4110, the issuer computer system may determine purveyor information based at least on the user input information. For example, the user input information may include information that is based at least on one or more transactions. For instance, account information associated with a purveyor may be determined from the purveyor information and/or based at least on one or more transactions.

At 4120, the issuer computer system may provide declination information, based at least on the purveyor information, to one or more processor computer systems. For example, the one or more processor computer systems may be associated with one or more of debit/credit processing networks. For instance, the one or more of debit/credit processing networks may include one or more of NYCE, PULSE, STAR, and SHAZAM, among others. In one or more embodiments, the declination information may instruct the one or more of debit/credit processing networks to decline one or more future requests for compensation from one or more purveyors to one or more accounts associated with the user. In one example, the declination information may instruct the one or more of debit/credit processing networks to permanently decline one or more future requests for compensation from one or more purveyors to one or more accounts associated with the user. In another example, the declination information may instruct the one or more of debit/credit processing networks to decline one or more future requests for compensation from one or more purveyors to one or more accounts associated with the user for a period of time.

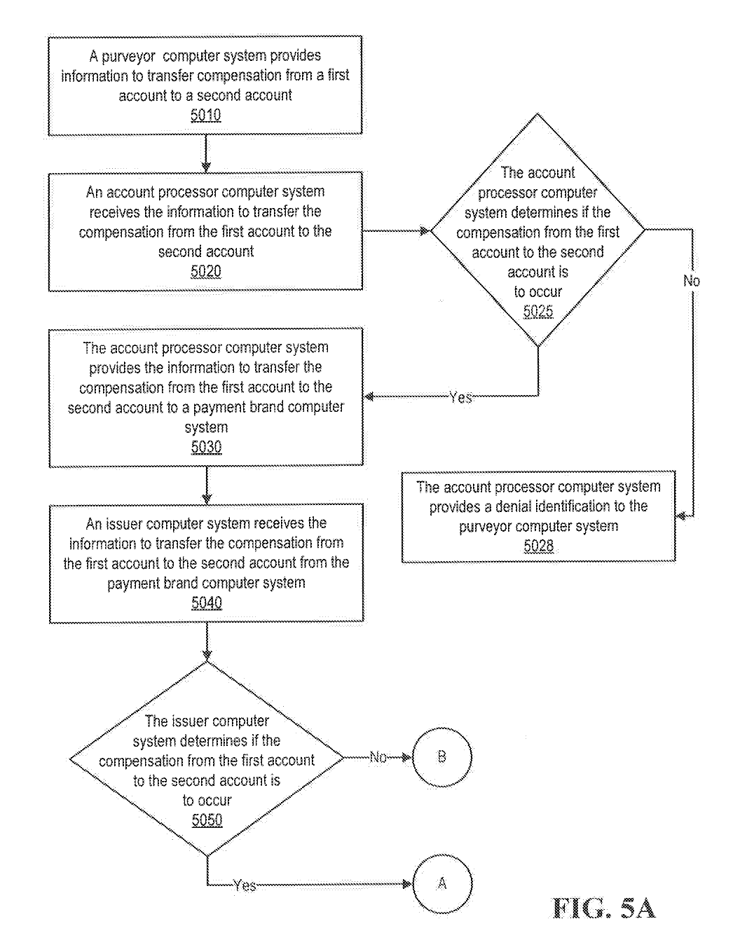

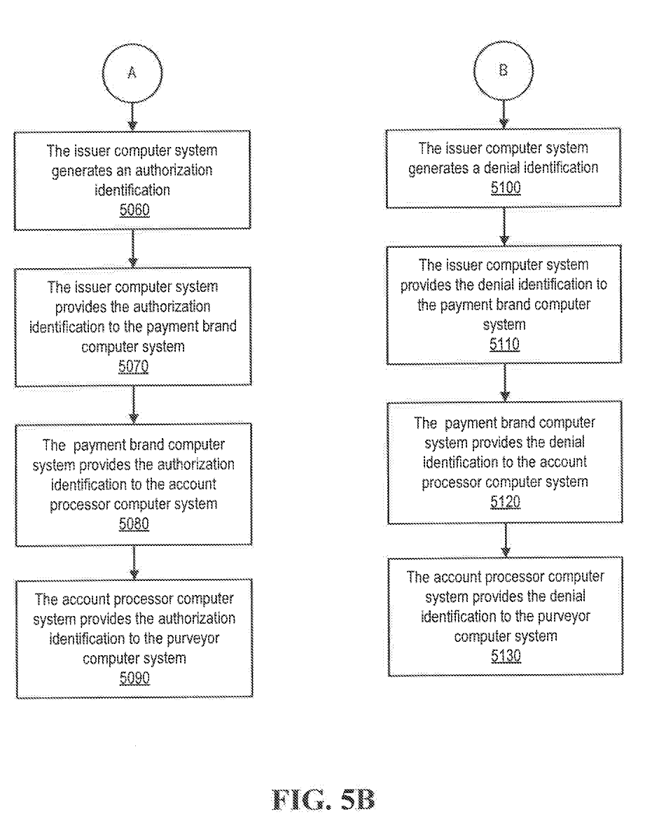

Turning now to FIGS. 5A and 5B, another example method of processing compensation. is illustrated, according to one or more embodiments. In one or more embodiments, method elements 5010 and 5020 may be performed in accordance with method elements 3010 and 3020, respectively. At 5025, the account processor computer system may determine if the compensation from the first account to the second account is to occur. In one or more embodiments, the account processor computer system may have received declination information that may instruct the account processor computer system to decline a request for compensation associated with the first account and the second account. For example, the account processor computer system may utilize the declination information in determining if the compensation from the first account to the second account is to occur.

If the account processor computer system determines that the compensation from the first account to the second account is to occur, the method may proceed to 5030. In one example, no declination information may be associated with the first account and the second account, and the method may proceed to 5030. In another example, the account processor computer system may ignore any declination information associated with the first account and the second account, and the method may proceed to 5030. If the account processor computer system determines that the compensation from the first account to the second account is not to occur, the account processor computer system may provide a denial identification to the purveyor computer system at 5028. For example, the denial identification may include a transaction identification and/or a denial number. In one or more embodiments, if compensation from the first account to the second account is not to occur, the request for compensation from the first account to the second account may be declined.

In one or more embodiments, method elements 5030-5130 may be performed in accordance with method elements 3030-3130, respectively. In one or more embodiments, determining, at 5050, if the compensation from the first account to the second account is to occur may include determining if declination information indicates that one or more requests for compensation associated with the first account and the second account are to be declined. In one example, declination information that may instruct the account processor computer system to decline a request for compensation associated with the first account and the second account may not have been provided to the account processor and/or to one or more of debit/credit processing networks. In another example, the account processor and/or one or more of debit/credit processing networks may ignore any declination information associated with the first account and the second account. In one or more embodiments, denying and/or declining a transfer of compensation from the first account to the second account may include performing one or more of method elements 5100-5130.

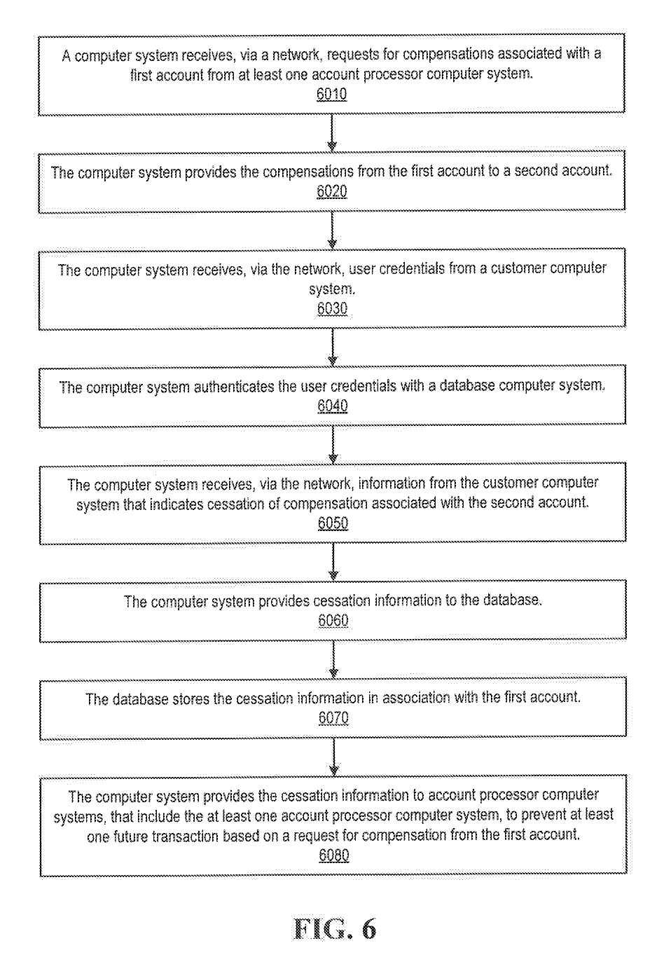

Turning now to FIG. 6, an example of a method of operating a computer system is illustrated, according to one or more embodiments. At 6010, a computer system may receive, via a network, requests for compensations associated with a first account from at least one account processor computer system. For example, an issuer computer system may receive, via network 2010, the requests for the compensations associated with the first account (e.g., a bank account, a debit card account, a credit card account, etc.) from the at least one account processor computer system. For instance, the at least one account processor computer system may be an account processor computer system associated with at least one of VISA, MASTERCARD, DISCOVER, NYCE, MAESTRO, PULSE, STAR, SHAZAM, and PAYPAL, among others. In one or more embodiments, the requests for the compensations associated with the first account may be associated with a subscription or a periodic payment. In one or more embodiments, the first account may be associated with one or more of a checking account, a debit card account, and credit card account, among others. In one example, the checking account may be associated with a checking account number. In a second example, the debit card account may be associated with a debit card number. In another example, the credit card account may be associated with a credit card number.

At 6020, the computer system may provide compensations from the first account to a second account. For example, the second account may be associated with a purveyor of one or more goods and/or one or more services. At 6030, the computer system may receive, via the network, user credentials from a customer computer system. For example, the issuer computer system may receive, via network 2010, the user credentials from the customer computer system. For instance, the customer computer system may include at least one of an automated teller machine, a wireless telephone (e.g., a smartphone), a laptop computing device, a desktop computing device, and a tablet computing device, among others. In one or more embodiments, the user credentials may include a username and a password associated with the first account.

At 6040, the computer system may authenticate the user credentials with a database. For example, the issuer computer system may authenticate the user credentials with a computer system that includes a database. For instance, the user credentials may include a username and a password, and the issuer computer system may authenticate the username and the password with the database. At 6050, the computer system may receive, via the network, information from the customer computer system that indicates cessation of compensation associated with the second account. For example, the issuer computer system may receive, via network 2010, the information from the customer computer system that indicates cessation of compensation associated with the second account. For instance, the information that indicates cessation of compensation associated with the second account may include stop payment information associated with the second account (e.g., stop payment for one or more goods and/or one or more services). In one or more embodiments, the issuer computer system may assess a fee to at least one of the first account and the second account. For example, the issuer computer system may assess a fee to at least one of the first account and the second account in response to receiving the information from the customer computer system that indicates cessation of compensation associated with the second account.

At 6060, the computer system may provide cessation information to the database. At 6070, the database may store the cessation information. In one or more embodiments, the database may create a new rule, based on the cessation information, for a compensation cessation. For example, the new rule for the compensation cessation may stop compensation for a specific item. For instance, the new rule for the compensation cessation may cease a recurring compensation for a gym membership, while a grocery store compensation would not be declined.

In one or more embodiments, the new rule for the compensation cessation may include a purveyor identification. In one or more embodiments, the new rule for the compensation. cessation may include an item identification. In one example, the item identification may identify a good. In another example, the item identification may identify a service. In one or more embodiments, the new rule for the compensation cessation may include a purchase type. In one example, the purchase type may include a good identification and/or a type of good. In another example, the purchase type may include a service identification and/or a type of service. In one or more embodiments, the database may log and/or store information associated with compensation cessation. For example, the database may log and/or store transaction information as the transaction information is provided from one computer system to another computer system. For instance, the information logged and/or stored via the database may be utilized for regulatory and/or oversight purposes.

At 6080, the computer system may provide the cessation information to account multiple processor computer systems, that includes the at least one account processor computer system, which instructs the account processor computer systems to decline at least one future transaction based on a request for compensation from the first account. For example, the account processor computer systems may be an account processor computer systems associated with one or more of VISA, MASTERCARD, DISCOVER, NYCE, MAESTRO, PULSE, STAR, SHAZAM, and PAYPAL, among others.

In one or more embodiments, providing declination information to one or more of debit/credit processing networks may reduce network traffic. For example, network traffic associated with method elements 5030-5130 may be averted if declination information associated with the first account and the second account indicates that one or more requests for compensation associated with the first account and the second account are to be declined.

In one or more embodiments, even though the computer system provides the cessation information to the account processor computer systems, which instructs the account processor computer systems to decline at least one future transaction based on a request for compensation from the first account, the computer system may also decline the at least one future transaction based on the request for compensation from the first account. In one example, the account processor computer systems may not receive and/or process the cessation information, which instructs the account processor computer systems to decline the at least one future transaction based on the request for compensation from the first account, in a timely fashion. In a second example, the account processor computer systems may receive the cessation information, which instructs the account processor computer systems to decline the at least one future transaction based on the request for compensation from the first account, but ignore the cessation information. In another example, the account processor computer systems may receive the cessation information, which instructs the account processor computer systems to decline the at least one future transaction based on the request for compensation from the first account, but delete and/or lose the cessation information after a period of time.

In one or more embodiments, even though the computer system provides the cessation information to the account processor computer systems, which instructs the account processor computer systems to decline at least one future transaction based on a request for compensation from the first account, the computer system may also decline the at least one future transaction based on the request for compensation from the first account regardless of processing network. For example, the computer system may receive, from a first account processor computer system of the account processor computer systems, a first request for compensation from the first account (e.g., the customer account) to the second account (e.g., the purveyor account) and may receive, from a second account processor computer system of the account processor computer systems, a second request for compensation from the first account to the second account. For instance, the first account processor computer system and the second account processing computer system are associated with different processing networks, and the computer system may decline the first request and the second request based at least on the cessation information.

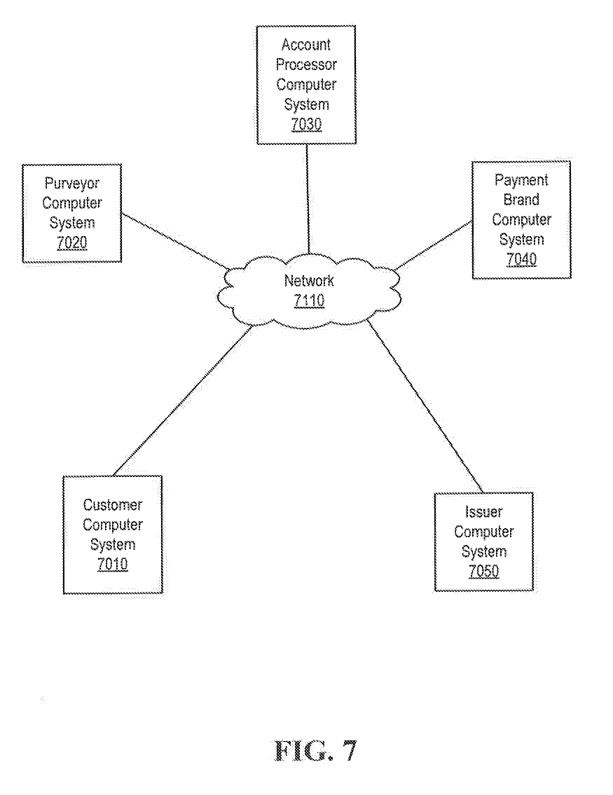

Turning now to FIG. 7, an example of a customer computer system, a purveyor computer system, an account processor computer system, a payment brand computer system, and an issuer computer system coupled to a network is illustrated, according to one or more embodiments. As shown, a customer computer system 7010, a purveyor computer system 7020, an account processor computer system 7030, a payment brand computer system 7040, and an issuer computer system 7050 coupled to a network 7110. In one or more embodiments, one or more of customer computer system 7010, purveyor computer system 7020, account processor computer system 7030, payment brand computer system 7040, and issuer computer system 7050 may include one or more structures and/or one or more functionalities as those described with reference to computer system 1010. In one or more embodiments, network 7110 may include one or more structures and/or one or more functionalities as those described with reference to network 2010.

In one or more embodiments, customer computer system 7010 may be utilized by a banking customer (e.g., a user). For example, customer computer system 7010 may include one or more of an automated teller machine, a wireless telephone smartphone), a laptop computing device, and a tablet computing device, among others. In one instance, the banking customer may utilize customer computer system 7010 in accessing one or more systems and/or one or more services offered by issuer computer system 7050 (e.g., a banking computer system). In another instance, the banking customer may utilize customer computer system 7010 to manage a bank account that the banking customer maintains with a bank. In one or more embodiments, purveyor computer system 7020 may be utilized by a purveyor of one or more goods and/or one or more services. For example, purveyor computer system 7020 may be utilized by the purveyor to transfer compensation from a first account (e.g., a customer banking account) to a second account (e.g., a purveyor banking account). For instance, purveyor computer system 7020 may be associated with a merchant (e.g., purveyor), such as a gym, a grocery store, cable television company, and a streaming media service, among others, that receives compensation from the customer.

In one or more embodiments, account processor computer system 7030 may be associated with one or more of debit/credit processing networks. For instance, the one or more of debit/credit processing networks may include one or more of NYCE, PULSE, STAR, and SHAZAM, among others. In one or more embodiments, purveyor computer system 7020 may be configured to provide compensation requests to account processor computer system 7030. For example, a compensation request may include a request for a transfer of compensation from a first account (e.g., a customer banking account) to a second account (e.g., a purveyor banking account). In one or more embodiments, payment brand computer system 7040 may be associated with debit card and/or credit card brand. For example, the brand may include MASTERCARD, DISCOVER, AMERICAN EXPRESS, or VISA, among others. For instance, account processor computer system 7030 may be configured to provide compensation requests to payment brand computer system 7040. In one or more embodiments, issuer computer system 7050 may be associated with a bank that issued a debit card or a credit card to the customer. For example, the bank may maintain an account on behalf of the customer. For instance, the account may be associated with the debit card or the credit card that the bank issued to the customer. In one or more embodiments, one or more of account processor computer system 7030 and payment brand computer system 7040 may be configured to provide compensation requests to issuer computer system 7050.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system, comprising:
one or more processors;
a memory medium, coupled to the one or more processors;
wherein the memory medium stores instructions that are executable by the one or more processors and that when executed by the one or more processors, cause the system to:
receive, via a network and from at least one account processor computer system, a plurality of requests for a plurality of compensations associated with a first account;
provide the plurality of compensations from the first account to a second account;
receive, via the network, user credentials from a customer computer system;
authenticate the user credentials with a database;
receive, via the network, information from the customer computer system that indicates cessation of compensation associated with the second account; and
provide cessation information to a plurality of account processor computer systems, which instructs the plurality of account processor computer systems to decline at least one future transaction based on a request for compensation from the first account, wherein the plurality of account processor computer systems include the at least one account processor computer system.

2. The system of claim 1, wherein the memory medium farther stores instructions that are executable by the one or more processors and that when executed by the one or more processors, cause the system to further:
provide the cessation information to the database.

3. The system of claim 1,
wherein the customer computer system includes at least one of an automated teller machine, a wireless telephone, a laptop computing device, a desktop computing system, and a tablet computing device; and
wherein the first account is associated with one or more of a checking account, a debit card account, and credit card account.

4. The system of claim 1, wherein the memory medium further stores instructions that are executable by the one or more processors and that when executed by the one or more processors, cause the system to further:
assess a fee to at least one of the first account and the second account.

5. The system of claim 1, wherein the second account is associated with a merchant that purveys one or more of a good and a service.

6. The system of claim 1, wherein the memory medium further stores instructions that are executable by the one or more processors and that when executed by the one or more processors, cause the system to further:
after the system receives, via the network, the information from the customer computer system that indicates the cessation of compensation associated with the second account:
receive another request for another compensation associated with the first account from the at least one account processor computer system and associated with the second account; and
decline the request for the other compensation associated with the first account from the at least one account processor computer system and associated with the second account.

7. The system of claim 1, wherein the memory medium further stores instructions that are executable by the one or more processors and that when executed by the one or more processors, cause the system to further:
after the system receives, via the network, the information from the customer computer system that indicates the cessation of compensation associated with the second account:
receive, from a first account processor computer system of the plurality of account processor computer systems, a first request for compensation from the first account to the second account;
receive, from a second account processor computer system of the plurality of account processor computer systems, a second request for compensation from the first account to the second account, wherein the first account processor computer system and the second account processing computer system are associated with different processing networks; and
decline the first request and the second request based at least on the cessation information.

8. A method, comprising:
a computer system receiving, via a network and from at least one account processor computer system, a plurality of requests for a plurality of compensations associated with a first account;
the computer system providing the plurality of compensations from the first account to a second account;
the computer system receiving, via the network, user credentials from a customer computer system;
the computer system authenticating the user credentials with a database;
the computer system receiving, via the network, information from the customer computer system that indicates cessation of compensation associated with the second account; and
the computer system providing cessation information to a plurality of account processor computer systems, which instructs the plurality of account processor computer systems to decline at least one future transaction based on a request for compensation from the first account, wherein the plurality of account processor computer systems include the at least one account processor computer system.

9. The method of claim 8, further comprising:
the computer system providing the cessation information to the database; and
the database storing the cessation information in association with the first account.

10. The method of claim 8,
wherein the customer computer system includes at least one of an automated teller machine, a wireless telephone, a laptop computing device, a desktop computing system, and a tablet computing device; and
wherein the first account is associated with one or more of a checking account, a debit card account, and credit card account.

11. The method of claim 8, further comprising:
assessing a fee to at least one of the first account and the second account.

12. The method of claim 8, wherein the second account is associated with a merchant that purveys one or more of a good and a service.

14. The method of claim 8, further comprising:
after the computer system receiving, via the network, the information from the customer computer system that indicates the cessation of compensation associated with the second account:
the computer system receiving another request for another compensation associated with the first account from the at least one account processor computer system and associated with the second account; and
the computer system declining the request for the other compensation associated with the first account from the at least one account processor computer system and associated with the second account.

15. The method of claim 8, further comprising:
after the computer system receiving, via the network, the information from the customer computer system that indicates the cessation of compensation associated with the second account:
the computer system receiving, from a first account processor computer system of the plurality of account processor computer systems, a first request for compensation from the first account to the second account;
the computer system receiving, from a second account processor computer system of the plurality of account processor computer systems, a second request for compensation from the first account to the second account, wherein the first account processor computer system and the second account processing computer system are associated with different processing networks; and
the computer system declining the first request and the second request based at least on the cessation information.

16. A computer-readable non-transitory memory medium that comprises instructions executable by one or more processors of a system and that when the one or more processors executes the instructions, cause the system to:
receive, via a network and from at least one account processor computer system, a plurality of requests for a plurality of compensations associated with a first account;
provide the plurality of compensations from the first account to a second account;
receive, via the network, user credentials from a customer computer system;
authenticate the user credentials with a database;
receive, via the network, information from the customer computer system that indicates cessation of compensation associated with the second account; and
provide cessation information to a plurality of account processor computer systems, which. instructs the plurality of account processor computer systems to decline at least one future transaction based on a request for compensation from the first account, wherein the plurality of account processor computer systems include the at least one account processor computer system.

17. The computer-readable non-transitory memory medium of claim 16,
wherein the customer computer system includes at least one of an automated teller machine, a wireless telephone, a laptop computing device, a desktop computing system, and a tablet computing device; and
wherein the first account is associated with one or more of a checking account, a debit card account, and credit card account.

18. The computer-readable non-transitory memory medium of claim 16, wherein the computer-readable non-transitory memory medium further stores instructions that are executable by the one or more processors and that when executed by the one or more processors, cause the system to further:
assess a fee to at least one of the first account and the second account.

19. The computer-readable non-transitory memory medium of claim 16, wherein the computer-readable non-transitory memory medium further stores instructions that are executable by the one or more processors and that when executed by the one or more processors, cause the system to further:
after the system receives, via the network, the information from the customer computer system that indicates the cessation of compensation associated with the second account:
receive another request for another compensation associated with the first account from the at least one account processor computer system and associated with the second account; and
decline the request for the other compensation associated with the first account from the at least one account processor computer system and associated with the second account.

20. The computer-readable non-transitory memory medium of claim 16, wherein the computer-readable non-transitory memory medium further stores instructions that are executable by the one or more processors and that when executed by the one or more processors, cause the system to further:
after the system receives, via the network, the information from the customer computer system that indicates the cessation of compensation associated with the second account:
receive, from a first account processor computer system of the plurality of account processor computer systems, a first request for compensation from the first account to the second account;
receive, from a second account processor computer system of the plurality of account processor computer systems, a second request for compensation from the first account to the second account, wherein the first account processor computer system and the second account processing computer system are associated with different processing networks; and
decline the first request and the second request based at least on the cessation information.
